(19) United States
(12) Patent Application Publication
(10) Pub. No.: US 2026/0277204 A1
(43) Pub. Date: Sep. 17, 2026

(54) INFORMATION PROCESSING METHOD, INFORMATION PROCESSING DEVICE, AND PROGRAM

(71) Applicant: Panasonic Intellectual Property Management Co., Ltd., Osaka (JP)

(72) Inventors: Taichi SATO, Kyoto (JP); Naganori SHIRAKATA, Osaka (JP); Hiroshi FUJIWARA, Osaka (JP); Shunsaku TOSHIHIRO, Osaka (JP)

(21) Appl. No.: 19/471,023

(22) PCT Filed: Jan. 24, 2024
(86) PCT No.: PCT/JP2024/002101

§ 371 Date: Sep. 30, 2025

(30) Foreign Application Priority Data
Apr. 3, 2023 (JP) 2023-059980

(51) Int. Cl. G05B 23/02; G06T 11/60

(52) U.S. Cl. CPC G05B 23/0216; G06T 11/60

(57) ABSTRACT

An information processing method for optimizing control parameters in a device that executes an operation based on a plurality of the control parameters, the method performed by an information processing unit, including: causing the device to execute a plurality of operations included in all operations that can be executed by the device; acquiring a plurality of pieces of time-series measurement data related to a predetermined evaluation index measured in execution of each operation of the plurality of operations; creating a waveform based on the plurality of pieces of measurement data related to the respective operations, creating a superimposed image by superimposing a plurality of pieces of waveform information regarding the plurality of operations, and creating an operation screen including the superimposed image; and causing a display unit to display the operation screen by inputting data of the operation screen to the display unit.

### TECHNICAL FIELD

The present disclosure relates to an information processing method, an information processing device, and a program.

### BACKGROUND ART

A control parameter generation method according to the background art is disclosed in, for example, Patent Literature 1.

Conventionally, in optimization processing of control parameters, it is desired to provide useful information to a user in an easy-to-understand manner.

### CITATION LIST

### Patent Literature

Patent Literature 1: WO 2018/151215 A

### SUMMARY OF INVENTION

An object of the present disclosure is to obtain an information processing method, an information processing device, and a program capable of providing useful information to a user in an easy-to-understand manner.

An information processing method according to one aspect of the present disclosure is an information processing method for optimizing control parameters in a device that executes an operation based on a plurality of the control parameters, the method performed by an information processing unit, including: causing the device to execute a plurality of operations included in all operations that can be executed by the device; acquiring a plurality of pieces of time-series measurement data related to a predetermined evaluation index measured in execution of each operation of the plurality of operations; creating a waveform based on the plurality of pieces of measurement data related to the respective operations, creating a superimposed image by superimposing a plurality of pieces of waveform information regarding the plurality of operations, and creating an operation screen including the superimposed image; and causing a display unit to display the operation screen by inputting data of the operation screen to the display unit.

### BRIEF DESCRIPTION OF DRAWINGS

FIG. 1 is a diagram illustrating a configuration of a control parameter generation device according to an embodiment of the present disclosure in a simplified manner.

FIG. 2 is a diagram illustrating an example of the control parameter in a simplified manner.

FIG. 3 is a diagram illustrating an example of a selection rule in a simplified manner.

FIG. 4 is a schematic diagram illustrating an example of transition of a positional deviation of a driven object with respect to a target position.

FIG. 5 is a diagram illustrating an example of measurement data output by a sensor in a simplified manner.

FIG. 6 is a flowchart illustrating processing executed by an information processing unit.

FIG. 7 is a flowchart illustrating details of control parameter optimization processing.

FIG. 8 is a flowchart illustrating details of evaluation result output processing.

FIG. 9 is a diagram illustrating an example of an operation screen created based on a representative operation in a simplified manner.

FIG. 10 is a diagram illustrating an example of an operation screen created based on the evaluation operation in a simplified manner.

FIG. 11 is a diagram illustrating a superimposed image according to a first modification in a simplified manner.

FIG. 12 is a diagram illustrating a superimposed image according to a second modification in a simplified manner.

FIG. 13 is a diagram illustrating a superimposed image according to the second modification in a simplified manner.

FIG. 14 is a diagram illustrating a superimposed image according to a third modification in a simplified manner.

FIG. 15 is a diagram illustrating a superimposed image according to a fourth modification in a simplified manner.

FIG. 16 is a diagram illustrating a superimposed image in a simplified manner.

FIG. 17 is a diagram illustrating a first example of a superimposed image according to a fifth modification in a simplified manner.

FIG. 18 is a diagram illustrating a second example of a superimposed image according to the fifth modification in a simplified manner.

### DESCRIPTION OF EMBODIMENTS

### Knowledge Underlying Present Disclosure

As a method for generating appropriate control parameters of a drive unit in a production device including the drive unit such as a servomotor that drives a driven object, in recent years, a method for generating appropriate control parameters by searching for appropriate control parameters using a machine learning model or the like has been proposed (see, for example, Patent Literature 1).

In general, the number of control parameters of the drive unit used in the production device may be 50 or more. Further, a number of adjustment gradations may be 100 or more.

For example, in a case where the production device performs 80 operations, the number of control parameters of the drive source is 50, and the number of adjustment gradations of the control parameters is 100, the number of combinations thereof is 100⁵⁰×80.

The inventors have found a problem that in a case where control parameters are generated for such an enormous number of combinations, at a time of using a method for searching for appropriate control parameters using a machine learning model or the like, enormous time is required to search for appropriate control parameter or no matter how much time it takes, no appropriate control parameter cannot be acquired due to an excessively wide search range.

Therefore, the inventors have intensively repeated experiments and studies in order to achieve a parameter generation method capable of efficiently generating appropriate control parameters even in a case where control parameters are generated for an enormous number of combinations.

Through the above experiments and studies, the inventors have obtained findings such that, in a case where, for example, 80 operations are performed by the production device, appropriate control parameters can be generated more efficiently and reliably for combinations of all the 80 operations by repeating steps described below and finally searching for appropriate control parameters for all the 80 operations without searching for appropriate control parameters for all huge combinations from the beginning. The steps include a first step of searching for appropriate control parameters for some of the 80 operations, for example, only one operation, that is, only some combinations among the huge combinations, a next step of increasing the number of operations performed by the production device and searching for appropriate control parameters for a combination of two operations using a search result in the first step, and a still next step of further increasing the number of operations performed by the production device and searching for appropriate control parameters, for example, for a combination of four operations using a search result in the previous step.

Furthermore, the inventors have found that, in the optimization processing of control parameters, if the waveforms of the measurement data for each operation of the plurality of operations are created and the plurality of waveforms are displayed side by side, the display size of each waveform becomes too small due to the limitation of the screen size of the display unit, and useful information cannot be provided to the user in an easy-to-understand manner.

In order to solve such a problem, the inventors have found that it is possible to provide useful information to a user in an easy-to-understand manner by superimposing and displaying a plurality of waveforms.

The inventors further conducted experiments and studies based on the above findings, and conceived a control parameter generation method and the like according to the present disclosure described below.

Next, each aspect of the present disclosure will be described.

An information processing method according to a first aspect of the present disclosure is an information processing method for optimizing control parameters in a device that executes an operation based on a plurality of the control parameters, the method performed by an information processing unit, including: causing the device to execute a plurality of operations included in all operations that can be executed by the device; acquiring a plurality of pieces of time-series measurement data related to a predetermined evaluation index measured in execution of each operation of the plurality of operations; creating a waveform based on the plurality of pieces of measurement data related to the respective operations, creating a superimposed image by superimposing a plurality of pieces of waveform information regarding the plurality of operations, and creating an operation screen including the superimposed image; and causing a display unit to display the operation screen by inputting data of the operation screen to the display unit.

According to the first aspect, the information processing unit creates a superimposed image by superimposing a plurality of pieces of waveform information regarding a plurality of operations, and creates an operation screen including the superimposed image. In this manner, by superimposing and displaying the plurality of pieces of waveform information on the display unit, it is possible to provide useful information to the user in an easy-to-understand manner.

In the information processing method according to the second aspect of the present disclosure, in the first aspect, the plurality of operations may be all the operations or a plurality of representative operations selected from all the operations.

According to the second aspect, it is possible to provide useful information to the user in an easy-to-understand manner by superimposing and displaying a plurality of pieces of waveform information regarding all operations or a plurality of representative operations.

The information processing method according to a third aspect of the present disclosure, in the second aspect, may further include: receiving an operation input of selection information for selecting one piece of waveform information from the plurality of pieces of waveform information included in the operation screen displayed on the display unit; and changing the representative operation based on the selection information.

According to the third aspect, the user can change the representative operation through the operation screen displayed on the display unit, so that the convenience of the user can be improved.

In the information processing method according to a fourth aspect of the present disclosure, in any one of the first to third aspects, the plurality of pieces of waveform information may be a plurality of waveforms related to the plurality of operations or a plurality of evaluation values calculated based on the plurality of waveforms.

According to the fourth aspect, by displaying a plurality of waveforms or a plurality of evaluation values in a superimposed manner, it is possible to provide useful information to the user in an easy-to-understand manner.

In the information processing method according to a fifth aspect of the present disclosure, in any one of the first to fourth aspects, in the creating of the superimposed image, a display mode of the waveform information that has achieved a target value related to the evaluation index and a display mode of the waveform information that has not achieved the target value may be made different from each other among the plurality of pieces of waveform information.

According to the fifth aspect, by making the display mode of the waveform information that has achieved the target value different from the display mode of the waveform information that has not achieved the target value, it is possible to provide useful information to the user in an easy-to-understand manner.

In the information processing method according to a sixth aspect of the present disclosure, in any one of the first to fifth aspects, the operation screen may further include a first input field for selecting display of the waveform information that has achieved a target value related to the evaluation index among the plurality of pieces of waveform information, and a second input field for selecting display of the waveform information that has not achieved the target value, and in the creating of the superimposed image, in a case where selection information is input to the first input field, the waveform information that has achieved the target value among the plurality of pieces of waveform information may be included in the superimposed image, and in a case where selection information is input to the second input field, the waveform information that has not achieved the target value among the plurality of pieces of waveform information may be included in the superimposed image.

According to the sixth aspect, since the user can select the waveform displayed on the operation screen by inputting the selection information to the first input field and the second input field, the convenience of the user can be improved.

In the information processing method according to a seventh aspect of the present disclosure, in any one of the first to sixth aspects, the operation screen may further include a first input field for selecting a first evaluation index and a second input field for selecting a second evaluation index as the evaluation index, and in the creating of the waveform, in a case where selection information is input to the first input field, the waveform may be created based on the plurality of pieces of time-series measurement data related to the first evaluation index measured in execution of the operations, and in a case where selection information is input to the second input field, the waveform may be created based on the plurality of pieces of time-series measurement data related to the second evaluation index measured in execution of the operations.

According to the seventh aspect, since the user can select the evaluation index by inputting the selection information to the first input field and the second input field, the convenience of the user can be improved.

In the information processing method according to an eighth aspect of the present disclosure, in any one of the first to seventh aspects, in the creating of the waveform, a plurality of waveforms may be created for the operations by causing the device to execute the operations a plurality of times, and in the creating of the superimposed image, waveform information having a best evaluation value related to the evaluation index may be selected among a plurality of pieces of waveform information regarding each of the operations, and the superimposed image may be created by superimposing a plurality of pieces of best waveform information regarding the plurality of operations.

According to the eighth aspect, since the superimposed image is created by superimposing the waveform information with the best evaluation value among the plurality of pieces of waveform information regarding each operation, the user can easily specify the operation that requires further adjustment by referring to the superimposed image.

In the information processing method according to a ninth aspect of the present disclosure, in any one of the first to eighth aspects, in the creating of the superimposed image, the waveform information regarding the operations may be shifted or scaled in a time axis direction according to a target value related to the evaluation index in the operations.

According to the ninth aspect, since the waveform information shifted or scaled according to the target value related to the evaluation index in each operation can be displayed, the waveform information having the worst evaluation value can be appropriately specified, and the convenience of the user can be improved.

An information processing method according to a tenth aspect of the present disclosure is an information processing method for optimizing control parameters in a device that executes an operation based on a plurality of the control parameters, the method performed by an information processing unit, including: causing the device to execute a plurality of operations; acquiring a plurality of pieces of time-series measurement data related to a predetermined evaluation index measured in execution of each operation of the plurality of operations; creating a waveform based on the plurality of pieces of measurement data related to the respective operations, creating a superimposed image by superimposing a plurality of pieces of waveform information regarding the plurality of operations, and creating a screen including the superimposed image; and causing a display unit to display the screen by inputting data of the screen to the display unit, in which the superimposed image includes a figure that clearly indicates an evaluation value corresponding to waveform information having a worst evaluation value related to the evaluation index among the plurality of pieces of waveform information.

According to the tenth aspect, since the superimposed image includes a figure in which the evaluation value related to the evaluation index among the plurality of pieces of waveform information clearly indicates the evaluation value corresponding to the worst waveform information, the convenience of the user can be improved.

An information processing device according to an eleventh aspect of the present disclosure is an information processing device for optimizing control parameters in a device that executes an operation based on a plurality of the control parameters, the information processing device including: a control unit that causes the device to execute a plurality of operations included in all operations that can be executed by the device; an acquisition unit that acquires a plurality of pieces of time-series measurement data related to a predetermined evaluation index measured in execution of each operation of the plurality of operations; a creation unit that creates a waveform based on the plurality of pieces of measurement data related to the respective operations, creates a superimposed image by superimposing a plurality of pieces of waveform information regarding the plurality of operations, and creates an operation screen including the superimposed image; and an output unit that causes a display unit to display the operation screen by inputting data of the operation screen to the display unit.

According to the eleventh aspect, the information processing device creates a superimposed image by superimposing a plurality of pieces of waveform information regarding a plurality of operations, and creates an operation screen including the superimposed image. In this manner, by superimposing and displaying the plurality of pieces of waveform information on the display unit, it is possible to provide useful information to the user in an easy-to-understand manner.

A program according to a twelfth aspect of the present disclosure is a program for causing an information processing device for optimizing control parameters in a device that executes an operation based on a plurality of the control parameters to execute processing, the processing including: causing the device to execute a plurality of operations included in all operations that can be executed by the device; acquiring a plurality of pieces of time-series measurement data related to a predetermined evaluation index measured in execution of each operation of the plurality of operations; creating a waveform based on the plurality of pieces of measurement data related to the respective operations, creating a superimposed image by superimposing a plurality of pieces of waveform information regarding the plurality of operations, and creating an operation screen including the superimposed image; and causing a display unit to display the operation screen by inputting data of the operation screen to the display unit.

According to the twelfth aspect, the information processing device creates a superimposed image by superimposing a plurality of pieces of waveform information regarding a plurality of operations, and creates an operation screen including the superimposed image. In this manner, by superimposing and displaying the plurality of pieces of waveform information on the display unit, it is possible to provide useful information to the user in an easy-to-understand manner.

The present disclosure can also implement each characteristic configuration included in such a method or device as a program to be executed by a computer or as a system operated by this program. It is needless to say that such a computer program can be distributed via a computer-readable non-transitory recording medium such as a CD-ROM or via a communication network such as the Internet.

### EMBODIMENTS OF PRESENT DISCLOSURE

Embodiments of the present disclosure will be described below in detail with reference to the drawings. Elements denoted with the same reference symbol in different drawings represent the same or corresponding elements. Constituent elements, placement positions of the constituent elements, connection forms, the order of operations, and the like shown in the following embodiments are an example, and are not intended to limit the present disclosure. The present disclosure is limited only by the claims. Therefore, a constituent element that is not described in an independent claim indicating the most generic concept of the present disclosure among constituent elements in the following embodiments is not necessarily required to achieve the object of the present disclosure, but the constituent element is described as constituting a more preferable form.

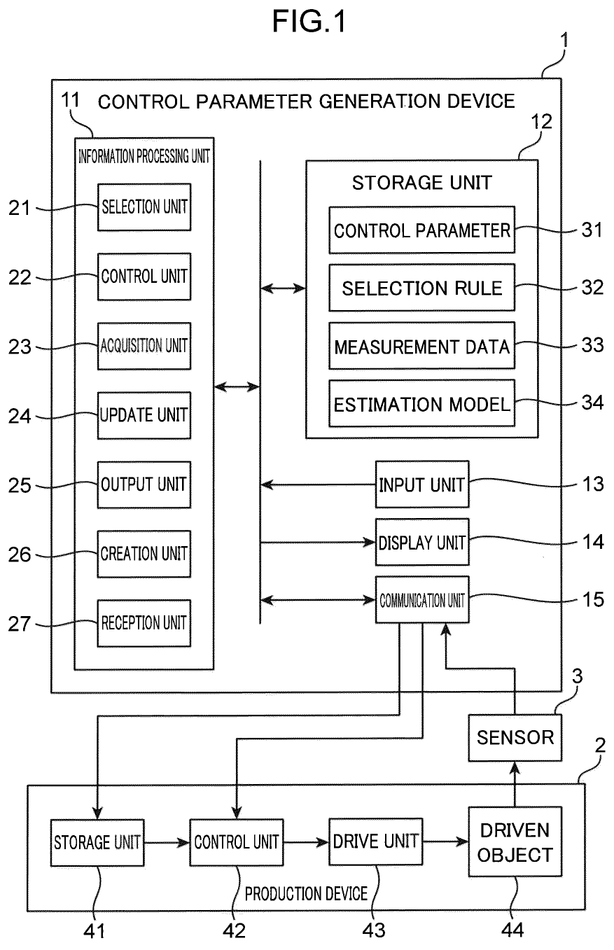

FIG. 1 is a diagram illustrating a configuration of a control parameter generation system according to an embodiment of the present disclosure in a simplified manner. The control parameter generation system is a system that optimizes a control parameter 31 by generating and updating the control parameter 31 used for a target production device 2. The control parameter generation system includes a control parameter generation device 1 and a sensor 3.

The production device 2 is a device used for producing a machine, and is a mounting device, a processing device, a machining device, a conveyance device, or the like for mounting, processing, machining, conveying, or the like of a machine. The production device 2 is installed, for example, in a production line of a factory.

The production device 2 can execute N (N is an integer of 3 or more) operations. N is, for example, 80. Note that the present disclosure is applicable not only to the production device 2 but also to any device capable of executing N operations.

The production device 2 includes a storage unit 41, a control unit 42, a drive unit 43, and a driven object 44.

The storage unit 41 is configured using an HDD, an SSD, a semiconductor memory, or the like.

The control unit 42 is configured using a processor such as a CPU.

The control unit 42 controls an operation of the drive unit 43, and drives the driven object 44.

The drive unit 43 is, for example, a servomotor, a fluid directional flow control valve used for controlling a pneumatic artificial muscle arm, or a fluid directional flow control valve used for controlling a hydraulic arm. The servomotor may be, for example, a rotary motor or a linear motor.

The driven object 44 is an object to be driven by the drive unit 43. For example, in a case where the drive unit 43 is a servomotor, the driven object 44 is a head that carries a part to be machined, a nozzle provided at the head to suck the part to be machined, or the like. In addition, the driven object 44 is a pneumatic artificial muscle arm, a hydraulic arm, or the like in a case where the drive unit 43 is a directional flow control valve.

The control unit 42 controls the drive unit 43 by outputting a command to the drive unit 43 to move the driven object 44 to a predetermined target position. The command output from the control unit 42 to the drive unit 43 may be, for example, a position command for commanding the position of the drive unit 43 or the driven object 44, or may be, for example, a torque command for commanding a torque of the drive unit 43.

The storage unit 41 stores the control parameter 31 generated and updated by the control parameter generation device 1. The control unit 42 controls the drive unit 43 based on the control parameter 31 read from the storage unit 41. In other words, the control unit 42 uses the control parameter 31 when controlling the drive unit 43. The number of control parameters 31 is, for example, 50.

The control parameter generation device 1 includes an information processing unit 11, a storage unit 12, an input unit 13, a display unit 14, and a communication unit 15.

The information processing unit 11 is configured using a processor such as a CPU. As functions implemented by the processor executing a program read from a nonvolatile recording medium such as a computer-readable ROM, the information processing unit 11 includes a selection unit 21, a control unit 22, an acquisition unit 23, an update unit 24, an output unit 25, a creation unit 26, and a reception unit 27. In other words, the program is a program for causing the information processing unit 11 as an information processing device mounted in the control parameter generation device 1 to function as the selection unit 21 (selection means), the control unit 22 (control means), the acquisition unit 23 (acquisition means), the update unit 24 (update means), the output unit 25 (output means), the creation unit 26 (creation means), and the reception unit 27 (reception means). Details of the processing content executed by each processing unit will be described later.

The storage unit 12 is configured using an HDD, an SSD, a semiconductor memory, or the like. The storage unit 12 stores the control parameter 31, a selection rule 32, measurement data 33, and an estimation model 34.

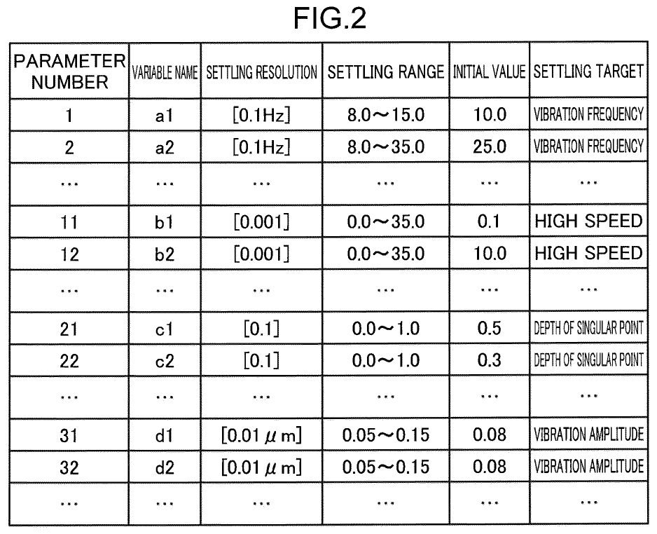

FIG. 2 is a diagram illustrating an example of the control parameter 31 in a simplified manner. The control parameters 31 includes parameters al and a2 for adjusting a vibration frequency of the driven object 44, parameters b1 and b2 for adjusting an increase in the speed of the driven object 44, parameters c1 and c2 for adjusting the depth of a singular point in the vibration characteristic of the driven object 44, parameters d1 and d2 for adjusting the vibration amplitude of the driven object 44, and the like. The control parameters 31 may include, for example, parameters having a trade-off relationship with each other, such as the parameters bl and b2, the parameters c1 and c2, and the parameters d1 and d2.

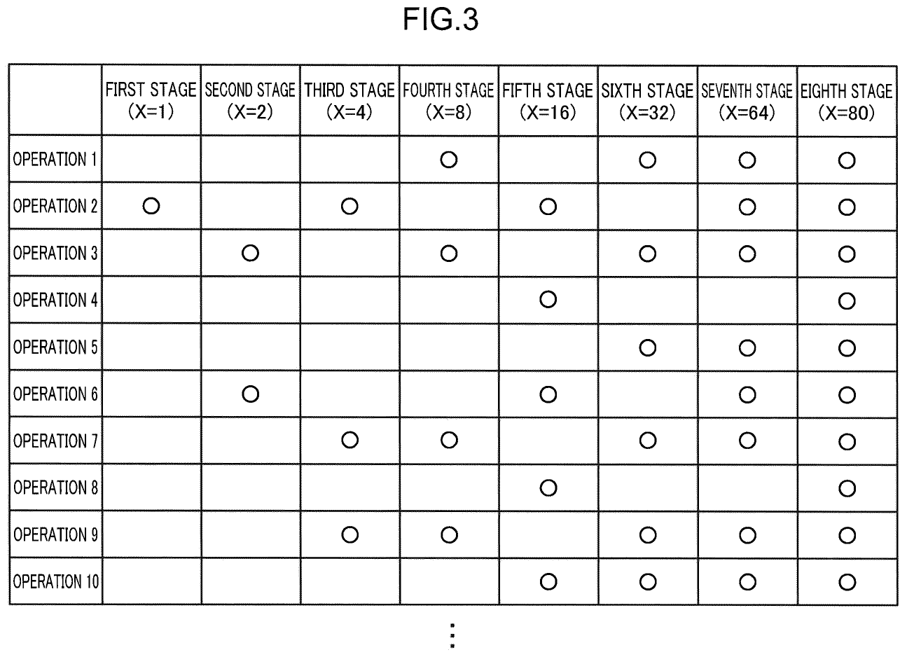

FIG. 3 is a diagram illustrating an example of the selection rule 32 in a simplified manner. The selection rule 32 indicates a rule when the selection unit 21 selects at least one representative operation from all the N operations that can be executed by the production device 2. The representative operation is an operation that the control parameter generation device 1 causes the production device 2 to execute in the control parameter optimization processing. In the example illustrated in FIG. 3, the representative operations are executed in the eight stages from the first to eighth stages, and the number X of operations included in the representative operations increases as the stage advances. For example, the number X of operations in the first stage is one, and the representative operation includes only operation 2. In addition, the number X of operations in the second stage is two, and the representative operations include operations 3 and 6. In addition, the number X of operations in the third stage is four, and the representative operations include operations 2, 7, 9 . . . . In addition, the number X of operations in the fourth stage is eight, and the representative operations include operations 1, 3, 7, 9 . . . . In addition, the number X of operations in the fifth stage is 16, and the representative operations include operations 2, 4, 6, 8, 10 . . . . In addition, the number X of operations in the sixth stage is 32, and the representative operations include operations 1, 3, 5, 7, 9, 10 . . . . In addition, the number X of operations in the seventh stage is 64, and the representative operations include operations 1, 2, 3, 5, 6, 7, 9, 10 . . . . In addition, the representative operations in the eighth stage include all the operations 1 to 50. Note that the representative operations at each stage may be all operations. In addition, the number of representative operations at each stage may be set to a fixed value, and the representative operations may be interchanged.

The selection rule 32 is designated in advance by the user by an operation input using the input unit 13. Note that the selection rule 32 is not limited to designation by the user, and the number of representative operations and the operations in each stage may be set in advance according to a predetermined rule, or the number of representative operations and the operations in each stage may be dynamically changed by a specifying method designated by the user.

In addition, the selection rule 32 may include setting information of an operation to be executed in the evaluation operation among all the N operations that can be executed by the production device 2. The evaluation operation is an operation that the control parameter generation device 1 causes the production device 2 to execute in the evaluation result output processing in order to comprehensively evaluate the operation of the production device 2. In the example of the present embodiment, the evaluation operation includes all operations. The evaluation operation is performed in at least one of a period of time during which the representative operations in each stage are performed and in a transition period of time from a certain stage to the next stage. In the example illustrated in FIG. 3, the representative operations of the eighth stage including all the operations may be executed as the evaluation operation including all the operations.

The evaluation operation is not limited to all the operations, and may be a differential operation between all the operation and the most recent representative operation with respect to the evaluation operation. For example, regarding a period in which the representative operations of the fourth stage are executed, since the representative operations include operations 1, 3, 7, 9 . . . , the evaluation operations executed within the period include operations 2, 4, 5, 6, 8, 10 . . . which are differences between all the operations and the representative operations. Furthermore, for example, regarding the period in which the representative operations of the fifth stage are executed, since the representative operations include operations 2, 4, 6, 8, 10 . . . , the evaluation operations executed within the transition period from the fifth stage to the sixth stage include operations 1, 3, 5, 7, 9 . . . , which are differences between all the operations and the representative operations.

Furthermore, the evaluation operation is not limited to all the operations, and may be a prescribed operation prescribed from all the operations. For example, a plurality of predetermined operations is determined as the prescribed operations in descending order of an influence on the operation performance of the production device 2 among all the operations. In the evaluation operation, the control parameter generation device 1 causes the production device 2 to execute only the specified operation.

Referring to FIG. 1, the measurement data 33 is data indicating a measurement value of a predetermined evaluation index measured by the sensor 3 in the execution of the representative operation and the evaluation operation. A plurality of pieces of measurement data 33 are accumulated in the storage unit 12 to form a database. The evaluation index may be any index as long as it can quantitatively evaluate the operation of the production device 2, and the settling time is used in the example of the present embodiment.

The sensor 3 is, for example, a position sensor, and measures the position of the driven object 44 in the representative operation and the evaluation operation along a time series. The measurement data 33 indicating the measurement position corresponding to each operation included in the representative operations and the evaluation operations is transmitted to the control parameter generation device 1. Note that the sensor 3 may be a torque sensor or the like instead of the position sensor.

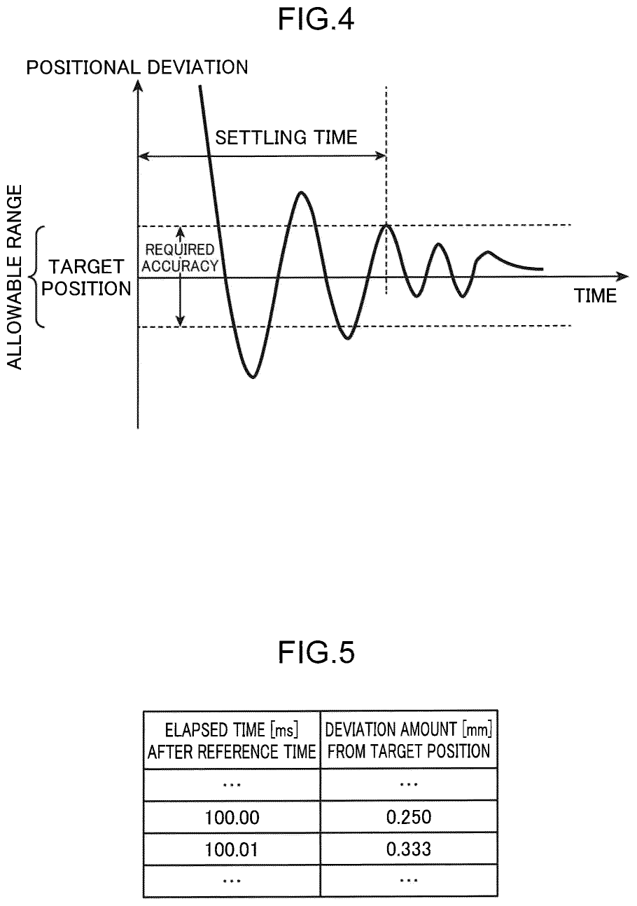

FIG. 4 is a schematic diagram illustrating an example of transition of a positional deviation of the driven object 44 with respect to a target position when the production device 2 moves the driven object 44 to the target position.

In FIG. 4, the horizontal axis represents time, and the vertical axis represents the positional deviation of the driven object 44 with respect to the target position.

As illustrated in FIG. 4, in this specification, the allowable range means a range in which the positional deviation from the target position is within required accuracy.

Further, as illustrated in FIG. 4, in this specification, the time (hereinafter, also referred to as “settling time”) of arrival at the allowable position that can be evaluated as having arrived at the target position means the time at which the driven object 44 finally arrives within the allowable range in a case where the driven object has not deviated from the allowable range again after arriving at the allowable range.

As illustrated in FIG. 4, in the present specification, the settling time refers to a time from the start of stopping of the driven object 44 based on a command to move the driven object 44 to the target position until the driven object 44 reaches an allowable position where it can be evaluated that the driving object reaches the target position, that is, a time from the stop start time to the settling time. Alternatively, the settling time refers to a time from the start of moving of the driven object 44 based on a command to move the driven object 44 to the target position until the driven object 44 reaches an allowable position where it can be evaluated that the driving object reaches the target position, that is, a time from the move start time to the settling time.

FIG. 5 is a diagram illustrating an example of the measurement data 33 output from the sensor 3 in a simplified manner.

As illustrated in FIG. 5, the measurement data 33 is data in which an elapsed time [ms] after a reference time and a deviation amount [mm] from the target position are associated on a one-to-one basis. Here, the reference time is a stop start time of the driven object 44 based on the command for setting the driven object 44 to the target position, or a move start time of the driven object 44 based on the command for moving the driven object 44 to the target position.

Referring to FIG. 1, the estimation model 34 is a learned model by machine learning for optimizing the control parameter 31. The estimation model 34 may include a machine learning program. Alternatively, the control parameter 31 may be optimized using a machine learning program instead of the estimation model 34. The update unit 24 executes optimization for shortening the longest settling time among the settling times corresponding to the respective operations included in the representative operations using the estimation model 34. As a result, the control parameter 31 is updated. The object to be optimized is not limited to the longest settling time, and may be an average value of a plurality of settling times, or may be a predetermined plurality of settling times or an average value thereof in descending order.

As an algorithm for optimization, a known algorithm such as a Bayesian optimization algorithm, an evolutionary strategy algorithm (CMA-ES), or a genetic algorithm (GA) can be used.

The information processing unit 11 and/or the storage unit 12 may be implemented in an external terminal or a server device capable of communicating with the control parameter generation device 1. The external terminal includes a personal computer, a smartphone, a tablet terminal, or the like. The server device includes an edge server, a cloud server, or the like.

The input unit 13 is configured using an arbitrary input device such as a mouse, a keyboard, or a touch panel.

The display unit 14 is configured using arbitrary device such as a liquid crystal display or an organic EL display.

The communication unit 15 is configured using a communication module compatible with an arbitrary communication method such as Bluetooth (registered trademark) or Wi-Fi.

The communication unit 15 transmits the control parameter 31 stored in the storage unit 12 to the production device 2. When the production device 2 receives the control parameter 31 from the control parameter generation device 1, the storage unit 41 overwrites the stored control parameter 31 with the received new control parameter 31. That is, the control parameter 31 is updated.

In addition, the communication unit 15 transmits a control signal for executing the representative operation or the evaluation operation to the production device 2. When the production device 2 receives the control signal from the control parameter generation device 1, the control unit 42 executes the representative operation or the evaluation operation by controlling the drive unit 43 based on the control signal and the control parameter 31 read from the storage unit 41.

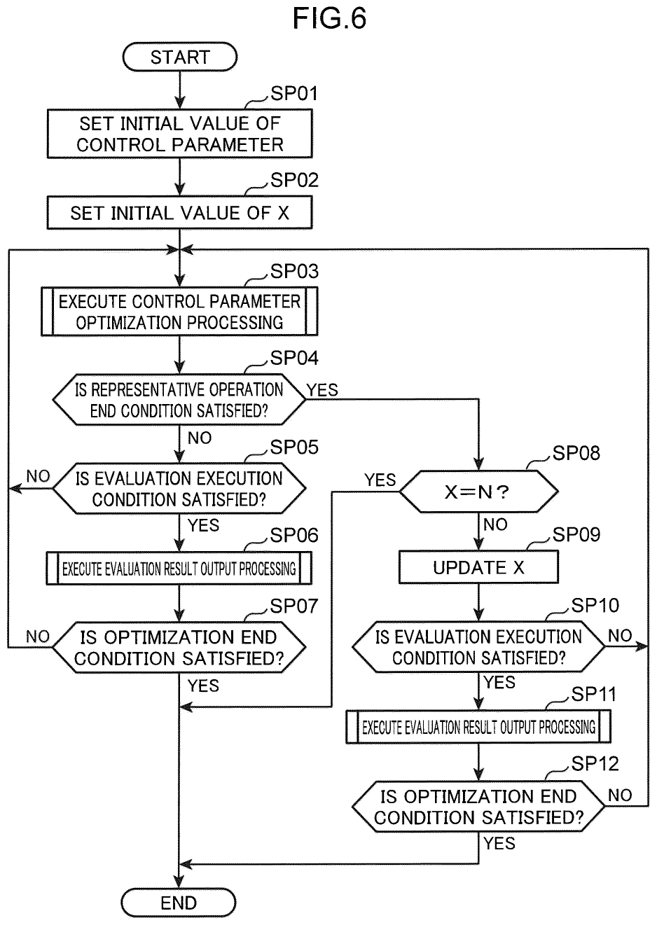

FIG. 6 is a flowchart illustrating processing executed by the information processing unit 11.

First, in step SP01, the update unit 24 sets an initial value of the control parameter 31. The initial value may be a predetermined value, a value designated by the user through an operation input using the input unit 13, or a value calculated by the update unit 24 using a calculation method designated by the user through an operation input using the input unit 13. The initial value of the control parameter 31 set by the update unit 24 is stored in the storage unit 12 and transmitted to the production device 2 by the communication unit 15. The production device 2 stores the received initial value of the control parameter 31 in the storage unit 41.

Next, in step SP02, the selection unit 21 sets an initial value of an integer-type variable indicating the number X of operations of the representative operations. The selection unit 21 refers to the selection rule 32 to set an initial value 1 of the integer-type variable as the number X of operations in the first stage. In the present embodiment, an example in which the initial value of the integer-type variable is 1 will be described, but the initial value may be an integer of 1 or more and N−1 or less and is not necessarily limited to 1. In addition, the initial value of the integer-type variable may be designated by the user by an operation input using the input unit 13.

Next, in step SP03, the information processing unit 11 executes control parameter optimization processing.

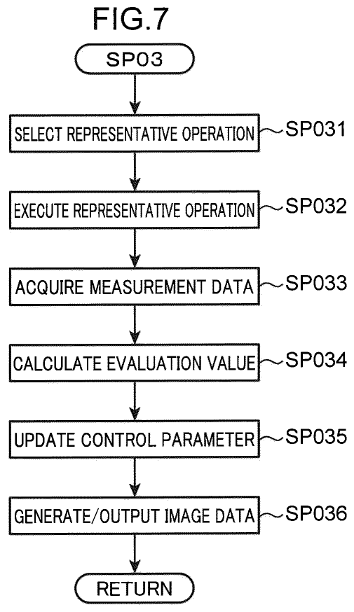

FIG. 7 is a flowchart illustrating details of the control parameter optimization processing.

First, in step SP031, the selection unit 21 selects X representative operations from all the N operations by referring to the selection rule 32. Specifically, the selection unit 21 selects one operation 2 as the representative operation of the first stage.

Next, in step SP032, the control unit 22 generates a control signal for causing the production device 2 to execute the representative operation selected by the selection unit 21. The control signal generated by the control unit 22 is transmitted to the production device 2 by the communication unit 15. When the production device 2 receives the control signal, the control unit 42 executes the representative operations including the X operations by controlling the drive unit 43 based on the control signal and the control parameter 31 read from the storage unit 41. When the production device 2 executes X operations, the sensor 3 transmits X pieces of measurement data 33 corresponding to each of the X operations included in the representative operations to the control parameter generation device 1. The communication unit 15 receives the X pieces of measurement data 33 transmitted from the sensor 3, stores the X pieces of measurement data in the storage unit 12, and inputs the X pieces of measurement data to the information processing unit 11.

Next, in step SP033, the acquisition unit 23 acquires X pieces of measurement data 33 corresponding to each of the X operations included in the representative operations from the communication unit 15.

Next, in step SP034, the update unit 24 calculates an evaluation value of the evaluation index for each of the X pieces of measurement data 33 acquired by the acquisition unit 23. In the example of the present embodiment, the update unit 24 calculates the settling time for each of the X pieces of measurement data 33.

Next, in step SP035, the update unit 24 updates the control parameter 31 by executing optimization for shortening the longest settling time among the X settling times regarding the calculated X pieces of measurement data 33 using the estimation model 34. The control parameter 31 updated by the update unit 24 is stored in the storage unit 12 and transmitted to the production device 2 by the communication unit 15. The production device 2 stores the received updated control parameter 31 in the storage unit 41.

Next, in step SP036, the creation unit 26 creates a waveform based on the time-series measurement data 33 related to each operation of the X operations, creates a superimposed image by superimposing X pieces of waveform information regarding the X operations, and creates an operation screen including the superimposed image. For example, the creation unit 26 adopts the longest settling time among the X settling times as an evaluation value related to the current representative operation, and generates image data including an evaluation result indicating the evaluation value. In addition, the output unit 25 displays the operation screen on the display unit 14 by inputting the data of the operation screen created by the creation unit 26 to the display unit 14.

Referring to FIG. 6, after step SP03, in step SP04, the control unit 22 determines whether a predetermined representative operation end condition is satisfied. As the representative operation end condition, a target value of the evaluation value in each stage may be set, the upper limit number of times of repetition of the optimization processing in each stage may be set, or the upper limit time of the execution time of the optimization processing in each stage may be set. For example, in a case where the target value of the evaluation value is set as the representative operation end condition, the control unit 22 determines that the representative operation end condition is not satisfied in a case where the evaluation value of the latest representative operation (the longest one among the X settling times) exceeds the target value, and determines that the representative operation end condition is satisfied in a case where the evaluation value of the latest representative operation is equal to or less than the target value.

In a case where the representative operation end condition is not satisfied (step SP04: NO), next, in step SP05, the control unit 22 determines whether the predetermined evaluation execution condition is satisfied. The evaluation execution condition includes that a certain time has elapsed from the reference time. The reference time includes an execution start time of the first representative operation in each stage and the execution start time of the previous evaluation operation. The control unit 22 includes a timer, resets the value of the timer at the reference time, and determines that a certain period of time has elapsed from the reference time when the value of the timer becomes equal to or greater than a threshold. In addition, the evaluation execution condition includes that the number of executions of the representative operation in each stage reaches a certain number of times. The control unit 22 includes a counter, resets the value of the counter before the start of execution of the first representative operation in each stage, and increments the value of the counter each time the representative operation is executed. The control unit 22 determines that the number of executions of the representative operation in each stage reaches a certain number of times when the value of the counter is equal to or greater than the threshold.

In a case where the evaluation execution condition is not satisfied (step SP05: NO), the processing in and after step SP03 is executed.

In a case where the evaluation execution condition is satisfied (step SP05: YES), next, in step SP06, the information processing unit 11 executes evaluation result output processing. The processing of step SP06 corresponds to evaluation result output processing executed within a period in which the representative operation of each stage is executed.

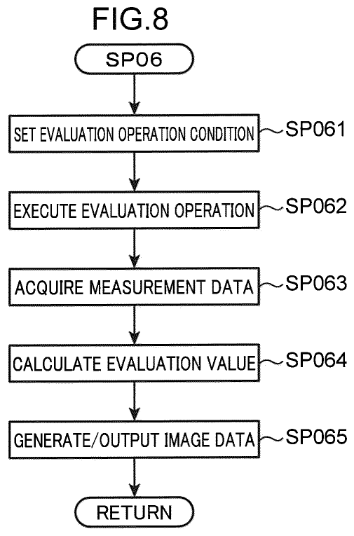

FIG. 8 is a flowchart illustrating details of the evaluation result output processing.

First, in step SP061, the control unit 22 sets an evaluation operation condition for executing the evaluation operation.

The evaluation operation condition includes operation designation information for designating an operation to be executed in the evaluation operation among all the N operations. The evaluation operation may be all the operations. An accurate comprehensive evaluation can be made by causing the production device 2 to perform all the operations as the evaluation operation. Furthermore, the evaluation operation may be a differential operation between all the operations and the most recent representative operation with respect to the evaluation operation. As the evaluation operation, by causing the production device 2 to perform the differential operation between all the operations and the most recent representative operation with respect to the evaluation operation, the efficiency of the evaluation operation can be improved while the accuracy of the comprehensive evaluation is being maintained. Furthermore, the evaluation operation may be a prescribed operation prescribed from all the operations. As the evaluation operation, the efficiency of the evaluation operation can be improved by causing the production device 2 to operate a prescribed operation prescribed from all the operations.

The evaluation operation condition includes setting information of the value of the control parameter 31 when the evaluation operation is executed. As the control parameter 31 at the time of executing the evaluation operation, the latest control parameter 31 stored in the storage unit 41 at the present time may be used as it is. Alternatively, the control parameter 31 when the evaluation operation is executed next time may be set based on a plurality of evaluation values related to a plurality of representative operations executed during a period from the time of execution of the previous evaluation operation to the present time. For example, the control unit 22 specifies the best evaluation value from a plurality of evaluation values related to a plurality of representative operations executed during a period from the time point of execution of the previous evaluation operation to the current time point, and sets the control parameter 31 set when the representative operation corresponding to the best evaluation value is executed as the control parameter 31 when the evaluation operation is executed next time. This makes it possible to improve the evaluation accuracy of the comprehensive evaluation by executing the evaluation operation.

Next, in step SP062, the control unit 22 generates a control signal for causing the production device 2 to execute the evaluation operation set in step SP061. The control signal generated by the control unit 22 is transmitted to the production device 2 by the communication unit 15. When the production device 2 receives the control signal, the control unit 42 executes the evaluation operation by controlling the drive unit 43 based on the control signal and the control parameter 31 read from the storage unit 41. When the production device 2 executes the evaluation operation, the sensor 3 transmits the measurement data 33 corresponding to each operation included in the evaluation operation to the control parameter generation device 1. The communication unit 15 receives the measurement data 33 transmitted from the sensor 3, stores the X pieces of measurement data in the storage unit 12, and inputs the X pieces of measurement data to the information processing unit 11.

Next, in step SP063, the acquisition unit 23 acquires the measurement data 33 corresponding to each operation included in the evaluation operation from the communication unit 15.

Next, in step SP064, the creation unit 26 calculates an evaluation value of the evaluation index for each piece of the measurement data 33 acquired by the acquisition unit 23. In the example of the present embodiment, the creation unit 26 calculates the settling time for each measurement data 33, and sets the longest settling time among the plurality of settling times regarding the plurality of measurement data 33 as the evaluation value related to the current evaluation operation.

Next, in step SP065, the creation unit 26 creates a waveform based on the time-series measurement data 33 related to each operation included in the evaluation operation, creates a superimposed image by superimposing a plurality of pieces of waveform information regarding a plurality of operations included in the evaluation operation, and creates an operation screen including the superimposed image. For example, the creation unit 26 adopts the longest settling time among the plurality of settling times as the evaluation value related to the current evaluation operation, and generates image data including the evaluation result indicating the evaluation value. In addition, the output unit 25 displays the operation screen on the display unit 14 by inputting the data of the operation screen created by the creation unit 26 to the display unit 14.

Referring to FIG. 6, in step SP07 next to step SP06, the control unit 22 determines whether a predetermined optimization end condition is satisfied. As the optimization end condition, a target value of the evaluation value related to the evaluation operation may be set, an upper limit number of summing times of total values of the number of repetitions of the optimization processing in all the stages up to the current time may be set, or an upper limit time of the execution time of the optimization processing in all the stages up to the current time may be set. For example, in a case where the target value of the evaluation value is set as the optimization end condition, the control unit 22 determines that the optimization end condition is not satisfied in a case where the evaluation value (longest settling time) of the most recent evaluation operation exceeds a target value, but determines that the optimization end condition is satisfied when the evaluation value of the most recent evaluation operation is equal to or less than the target value.

In a case where the optimization end condition is not satisfied (step SP07: NO), the processing of step SP03 and subsequent steps is executed.

In a case where the optimization end condition is satisfied (step SP07: YES), the optimization processing of the control parameter 31 ends. In a case where the evaluation result of the comprehensive evaluation by performing the evaluation operation satisfies the optimization end condition, the optimization processing ends even before the representative operations arrive at the final stage, and thus the time required for the optimization processing can be shortened.

In a case where the representative operation end condition is satisfied in the determination of step SP04 (step SP04: YES), next, in step SP08, the selection unit 21 determines whether the number X of operations included in the representative operations is equal to the number N of operations of all the operations.

In a case where X is equal to N (step SP08: YES), since the representative operation has reached the final stage (the eighth stage in the example of FIG. 3), the optimization processing of the control parameter 31 ends.

In a case where X is less than N (step SP08: NO), since the representative operation has not reached the final stage, the selection unit 21 updates X by referring to the selection rule 32 in step SP09. That is, the selection unit 21 shifts the selection of the X representative operations from the current stage to the next stage from all the N operations.

Next, in step SP10, the control unit 22 determines whether a predetermined evaluation execution condition is satisfied. The evaluation execution condition includes that a certain time has elapsed from the reference time. The reference time includes the execution start time of the previous evaluation operation. The control unit 22 includes a timer, resets the value of the timer at the reference time, and determines that a certain period of time has elapsed from the reference time when the value of the timer becomes equal to or greater than a threshold.

In a case where the evaluation execution condition is not satisfied (step SP10: NO), the processing in and after step SP03 is executed.

In a case where the evaluation execution condition is satisfied (step SP10: YES), next, in step SP11, the information processing unit 11 executes evaluation result output processing. The processing of step SP11 corresponds to evaluation result output processing executed within a transition period from a certain stage to the next stage. Details of the evaluation result output processing in step SP11 are illustrated by the flowchart illustrated in FIG. 8. The determination processing in step SP10 may be omitted, and step SP11 may be always executed in a case where X is updated.

Next, in step SP12, the control unit 22 determines whether a predetermined optimization end condition is satisfied. Details of the optimization end condition in step SP12 are similar to the details of the optimization end condition in step SP07.

In a case where the optimization end condition is not satisfied (step SP12: NO), the processing of step SP03 and subsequent steps is executed.

In a case where the optimization end condition is satisfied (step SP12: YES), the optimization processing of the control parameter 31 ends. In a case where the evaluation result of the comprehensive evaluation by performing the evaluation operation satisfies the optimization end condition, the optimization processing ends even before the representative operations arrive at the final stage, and thus the time required for the optimization processing can be shortened.

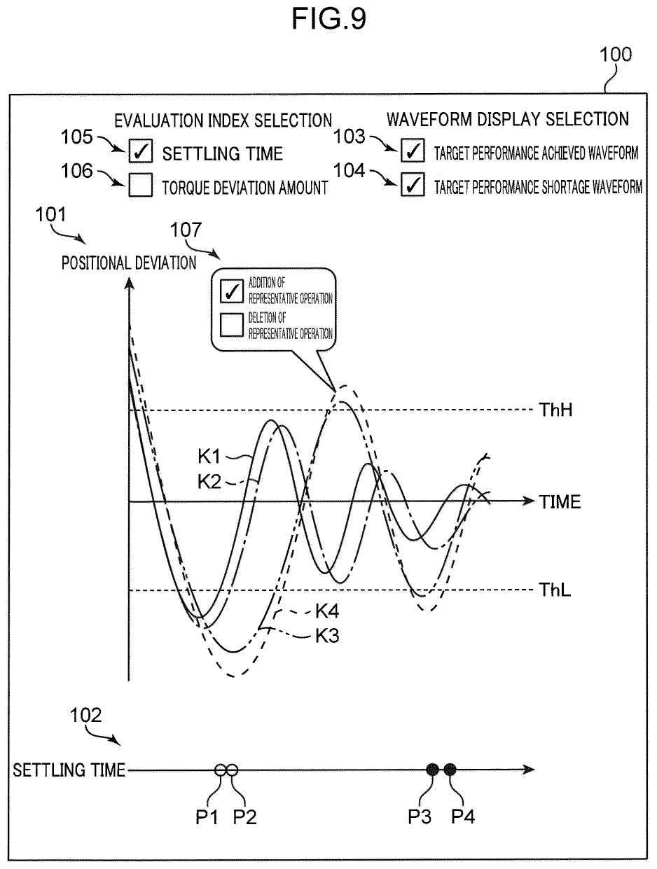

FIG. 9 is a diagram illustrating an example of an operation screen 100 created based on the result of the representative operation in step SP036 in a simplified manner.

The operation screen 100 includes a superimposed image 101 in which a plurality of waveforms K (K1 to K4) related to a plurality of (four in this example) representative operations are superimposed on the time axis. The waveform K is an example of waveform information. The superimposed image 101 includes an upper limit value ThH and a lower limit value ThL of the allowable range.

Further, the operation screen 100 includes a superimposed image 102 in which a plurality of evaluation values calculated based on the plurality of waveforms K (K1 to K4) related to the plurality of (four in this example) representative operations are superimposed on the time axis. The evaluation value is an example of waveform information. In the example of FIG. 9, the evaluation value is the settling time P (P1 to P4). The settling time P1 corresponding to the waveform K1 and the settling time P2 corresponding to the waveform K2 are equal to or less than the target value of the settling time, and the target performance is achieved. The settling time P3 corresponding to the waveform K3 and the settling time P4 corresponding to the waveform K4 exceed the target value of the settling time, and the target performance is not achieved.

In creating the superimposed images 101 and 102, the creation unit 26 makes the display mode of the waveform information (waveforms K1 and K2 and settling times P1 and P2) that has achieved the target value related to the evaluation index different from the display mode of the waveform information (waveforms K3 and K4 and settling times P3 and P4) that has not achieved the target value among the plurality of pieces of waveform information. For example, the creation unit 26 displays the waveforms K1 and K2 and the settling times P1 and P2 in blue, and displays the waveforms K3 and K4 and the settling times P3 and P4 in red.

The operation screen 100 includes a waveform display selection field. The waveform display selection field includes a first input field 103 for selecting display of the waveform information that has achieved the target value related to the evaluation index among the plurality of pieces of waveform information, and a second input field 104 for selecting display of the waveform information that has not achieved the target value.

The user can input selection information (check mark) to each of the first input field 103 and the second input field 104 by operation input using the input unit 13. The selection information input from the input unit 13 is received by the reception unit 27.

In a case where the selection information is input to the first input field 103 in the creation of the superimposed images 101 and 102, the creation unit 26 includes, in the superimposed images 101 and 102, waveform information (waveforms K1 and K2 and settling times P1 and P2) that has achieved the target value among the plurality of pieces of waveform information. On the other hand, in a case where the selection information is not input to the first input field 103, the creation unit 26 does not include the waveform information (waveforms K1 and K2 and settling times P1 and P2) that has achieve the target value among the plurality of pieces of waveform information in the superimposed images 101 and 102.

In a case where the selection information is input to the second input field 104 in the creation of the superimposed images 101 and 102, the creation unit 26 includes, in the superimposed images 101 and 102, waveform information (waveforms K3 and K4 and settling times P3 and P4) that has not achieved the target value among the plurality of pieces of waveform information. On the other hand, in a case where the selection information is not input to the second input field 104, the creation unit 26 does not include, in the superimposed images 101 and 102, the waveform information (waveforms K3 and K4 and settling times P3 and P4) that has not achieved the target value among the plurality of pieces of waveform information.

In the example illustrated in FIG. 9, since the selection information is input to both the first input field 103 and the second input field 104, the superimposed images 101 and 102 includes the waveforms K1 to K4 and the settling times P1 to P4.

In addition, the operation screen 100 includes an evaluation index selection field. The evaluation index selection field includes a first input field 105 for selecting a first evaluation index (settling time in this example) and a second input field 106 for selecting a second evaluation index (torque deviation amount in this example) as evaluation indexes. Note that an input field for selecting another evaluation index such as the overshoot amount may be further included.

The user can input selection information (check mark) to each of the first input field 105 and the second input field 106 by operation input using the input unit 13. The selection information input from the input unit 13 is received by the reception unit 27.

In a case where the selection information is input to the first input field 105 in the creation of the waveform K, the creation unit 26 creates the waveform K based on a plurality of pieces of time-series measurement data 33 related to the first evaluation index (settling time) measured using the position sensor in the execution of each operation of the representative operation.

On the other hand, in a case where the selection information is input to the second input field 106, the waveform K is created based on the plurality of pieces of time-series measurement data 33 related to the second evaluation index (torque deviation amount) measured using the torque sensor in the execution of each operation of the representative operation.

In the example illustrated in FIG. 9, since the selection information is input to the first input field 105, the settling time is used as the evaluation index.

In addition, in the superimposed image 101, when the user moves the mouse cursor onto any of the waveforms K by the operation input using the input unit 13, the selection information of the waveform K is received by the reception unit 27. The creation unit 26 displays a tool tip 107 for changing the representative operation in the vicinity of the selected waveform K. The tool tip 107 includes an addition item to which a check mark is input by the user in a case where it is desired to add the selected waveform K to the representative operation in the next stage, and a deletion item to which a check mark is input by the user in a case where it is desired to delete the selected waveform K from the representative operation in the current stage. The selection unit 21 changes the representative operation based on the selection information input to the tool tip 107.

In the superimposed image 102, when the user moves the mouse cursor to any of the settling times P by the operation input using the input unit 13, the selection information of the settling time P is received by the reception unit 27. The creation unit 26 highlights (for example, displays a thick line) the waveform K corresponding to the selected settling time P in the superimposed image 101.

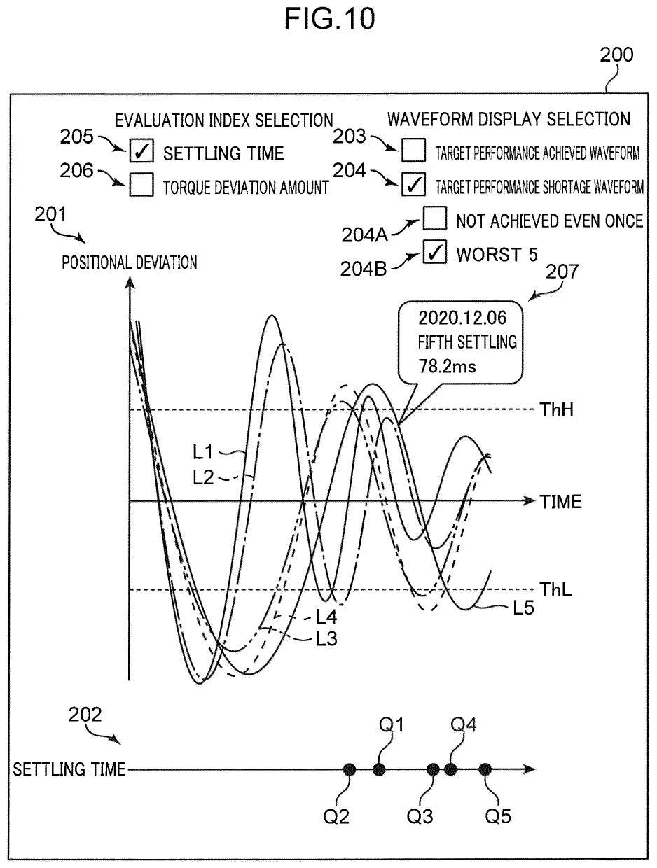

FIG. 10 is a diagram illustrating an example of an operation screen 200 created based on the result of the evaluation operation in step SP065 in a simplified manner.

The operation screen 200 includes a superimposed image 201 in which a plurality of waveforms L (L1 to L5) related to a plurality of (five in this example) evaluation operations are superimposed on the time axis. The waveform L is an example of waveform information. The superimposed image 201 includes an upper limit value ThH and a lower limit value ThL of the allowable range.

Further, the operation screen 200 includes a superimposed image 202 in which a plurality of evaluation values calculated based on a plurality of waveforms L (L1 to L5) related to a plurality of (five in this example) evaluation operations are superimposed on the time axis. The evaluation value is an example of waveform information. In the example of FIG. 10, the evaluation value is the settling time Q (Q1 to Q5). All of the settling times Q1 to Q5 corresponding to the waveforms L1 to L5 exceed the target value of the settling time, and the target performance is not achieved.

In creating the waveform L, the creation unit 26 creates a plurality of waveforms for each operation by causing the production device 2 to execute each operation of the evaluation operations a plurality of times. In creating the superimposed images 201 and 202, the creation unit 26 selects waveform information having the best evaluation value among a plurality of pieces of waveform information regarding each operation. The creation unit 26 creates the superimposed images 201 and 202 by superimposing a plurality of pieces of best waveform information (waveforms L1 to L5 and settling times Q1 to Q5) related to a plurality of operations.

Similarly to the operation screen 100, in creating the superimposed images 201 and 202, the creation unit 26 makes the display mode of the waveform information that has achieved the target value related to the evaluation index different from the display mode of the waveform information that has not achieved the target value among the plurality of pieces of waveform information.

The operation screen 200 includes a waveform display selection field. The waveform display selection field includes a first input field 203 for selecting display of the waveform information that has achieved the target value related to the evaluation index among the plurality of pieces of waveform information, and a second input field 204 for selecting display of the waveform information that has not achieved the target value.

The user can input selection information (check mark) to each of the first input field 203 and the second input field 204 by operation input using the input unit 13. The selection information input from the input unit 13 is received by the reception unit 27.

In a case where the selection information is input to the first input field 203 in the creation of the superimposed images 201 and 202, the creation unit 26 includes, in the superimposed images 201 and 202, waveform information that has achieved the target value among the plurality of pieces of waveform information. On the other hand, in a case where the selection information is not input to the first input field 203, the creation unit 26 does not include the waveform information that has achieve the target value among the plurality of pieces of waveform information in the superimposed images 201 and 202.

In a case where the selection information is input to the second input field 204 in the creation of the superimposed images 201 and 202, the creation unit 26 includes, in the superimposed images 201 and 202, waveform information (waveforms L1 to L5 and settling times Q1 to Q5) that has not achieved the target value among the plurality of pieces of waveform information. On the other hand, in a case where the selection information is not input to the second input field 204, the creation unit 26 does not include, in the superimposed images 201 and 202, the waveform information (waveforms L1 to L5 and settling times Q1 to Q5) that has not achieved the target value among the plurality of pieces of waveform information.

In the example illustrated in FIG. 10, since the selection information is not input to the first input field 203 and the selection information is input to the second input field 204, the superimposed images 201 and 202 include waveform information (waveforms L1 to L5 and settling times Q1 to Q5) that has not achieved the target value.

In a case where the selection information is input to the second input field 204, the creation unit 26 further includes selection items 204A and 204B of the shortage waveform in the operation screen 200. In the selection item 204A, a check mark is input by the user in a case where it is desired to display the waveform L of the operation that has never achieved the target value up to the current point of time. A check mark is input to the selection item 204B by the user in a case where it is desired to display the waveform information of the operations having five worst evaluation values at the present time. In the example of FIG. 10, since the selection information is input to the selection item 204B, the waveform information (waveforms L1 to L5 and settling times Q1 to Q5) of the operations having the five worst evaluation values at the present time is included in the superimposed images 201 and 202. Note that the number of operations selected by the selection item 204B is not limited to the worst five. Furthermore, in addition to the selection items 204A and 204B, a selection item from another viewpoint may be further added.

In addition, the operation screen 200 includes an evaluation index selection field. The evaluation index selection field includes a first input field 205 for selecting a first evaluation index (settling time in this example) and a second input field 206 for selecting a second evaluation index (torque deviation amount in this example) as evaluation indexes. Note that an input field for selecting another evaluation index such as the overshoot amount may be further included.

The user can input selection information (check mark) to each of the first input field 205 and the second input field 206 by operation input using the input unit 13. The selection information input from the input unit 13 is received by the reception unit 27.

In a case where the selection information is input to the first input field 205 in the creation of the waveform L, the creation unit 26 creates the waveform L based on a plurality of pieces of time-series measurement data 33 related to the first evaluation index (settling time) measured using the position sensor in the execution of each operation of the evaluation operation.

On the other hand, in a case where the selection information is input to the second input field 206, the waveform L is created based on the plurality of pieces of time-series measurement data 33 related to the second evaluation index (torque deviation amount) measured using the torque sensor in the execution of each operation of the evaluation operation.

In the example illustrated in FIG. 10, since the selection information is input to the first input field 205, the settling time is used as the evaluation index.

In addition, in the superimposed image 201, when the user moves the mouse cursor onto any of the waveforms L by the operation input using the input unit 13, the selection information of the waveform L is received by the reception unit 27. The creation unit 26 displays a tool tip 207 for describing details of the operation corresponding to the selected waveform L in the vicinity of the selected waveform L. The tool tip 207 includes information indicating the acquisition date and time of the measurement data 33 associated with the execution of the operation, information indicating the number of adjustment times of the operation, and information indicating the performance display (in this example, the settling time) of the operation.

In the superimposed image 202, when the user moves the mouse cursor to any of the settling times Q by the operation input using the input unit 13, the selection information of the settling time Q is received by the reception unit 27. The creation unit 26 highlights (for example, displays a thick line) the waveform L corresponding to the selected settling time Q in the superimposed image 201.

According to the control parameter generation device 1 according to the present embodiment, the information processing unit 11 creates the superimposed images 101, 102, 201, and 202 by superimposing a plurality of pieces of waveform information regarding a plurality of operations, and creates the operation screens 100 and 200 including the superimposed images 101, 102, 201, and 202. In this manner, by superimposing and displaying the plurality of pieces of waveform information on the display unit 14, it is possible to provide useful information to the user in an easy-to-understand manner. Note that one of the superimposed images 101 and 102 may be omitted, and one of the superimposed images 201 and 202 may be omitted.

Description is made hereinafter to various modifications of the embodiment of the present disclosure. Any of the modifications to be described below can be appropriately combined for application.

### First Modification

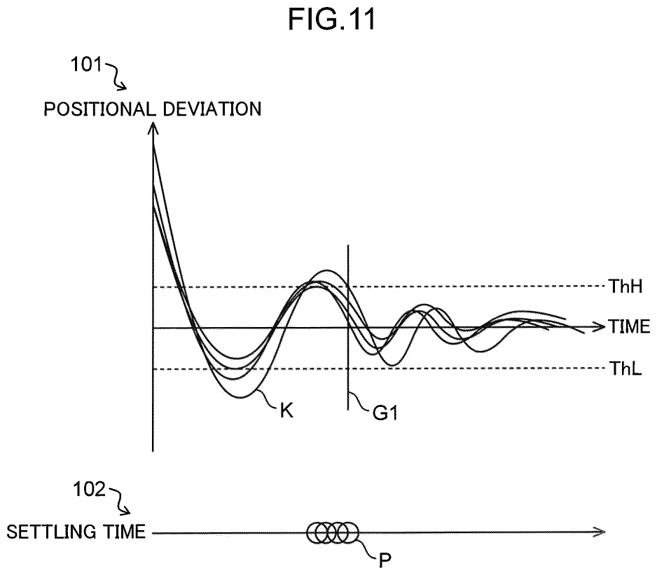

FIG. 11 is a diagram illustrating superimposed images 101 and 102 according to a first modification in a simplified manner. The creation unit 26 creates the superimposed image 101 including the plurality of waveforms K and a figure G1 indicated by the vertical line. The figure G1 is a figure for clearly indicating an evaluation value corresponding to a waveform having the worst evaluation value (in this example, the settling time P is the longest) among the plurality of waveforms K. In addition, the output unit 25 displays the operation screen 100 on the display unit 14 by inputting the data of the operation screen 100 created by the creation unit 26 to the display unit 14. Note that the figure G1 for clearly indicating the worst evaluation value is not limited to the plurality of waveforms related to the plurality of operations included in the representative operations, and may be displayed to be superimposed on the plurality of waveforms related to the plurality of operations included in the evaluation operation, the plurality of waveforms related to the plurality of operations included in all the operations, or the plurality of waveforms related to any plurality of operations. Furthermore, the operation screen 100 may be a simple screen that does not involve user operation.

According to the present modification, the superimposed image 101 includes the figure G1 that clearly indicates the evaluation value corresponding to the waveform information with the worst evaluation value related to the evaluation index among the plurality of pieces of waveform information. Therefore, since the user can recognize the worst evaluation value among the plurality of evaluation values corresponding to the plurality of pieces of waveform information at a glance, the convenience of the user can be improved.

### Second Modification

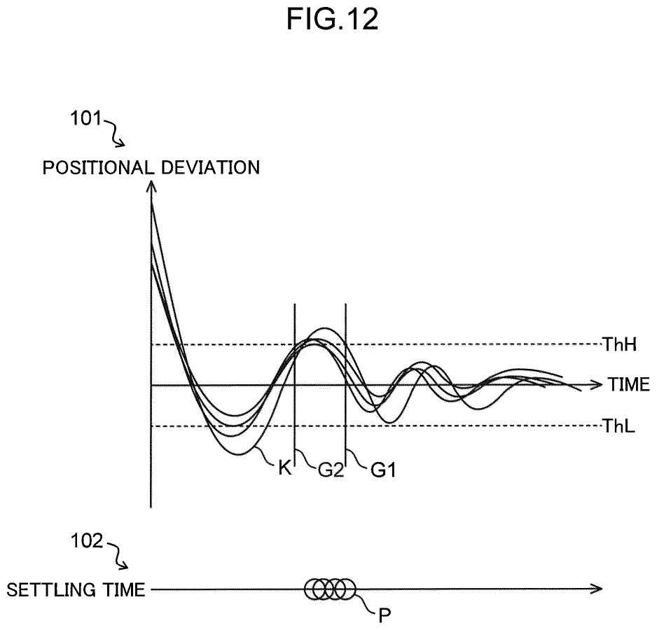

FIG. 12 is a diagram illustrating superimposed images 101 and 102 according to a second modification in a simplified manner. The creation unit 26 creates the superimposed image 101 including the plurality of waveforms K and figures G1 and G2 indicated by the vertical line. The figure G1 is a figure for clearly indicating an evaluation value corresponding to a waveform having the worst evaluation value (in this example, the settling time P is the longest) among the plurality of waveforms K. The figure G2 is a figure for clearly indicating the evaluation value corresponding to the evaluation operation in which the worst evaluation value (the longest settling time Q in this example) among the plurality of waveforms L is the best among the plurality of evaluation operations executed up to the present time. The evaluation operation may be all the operations. In addition, the output unit 25 displays the operation screen 100 on the display unit 14 by inputting the data of the operation screen 100 created by the creation unit 26 to the display unit 14.

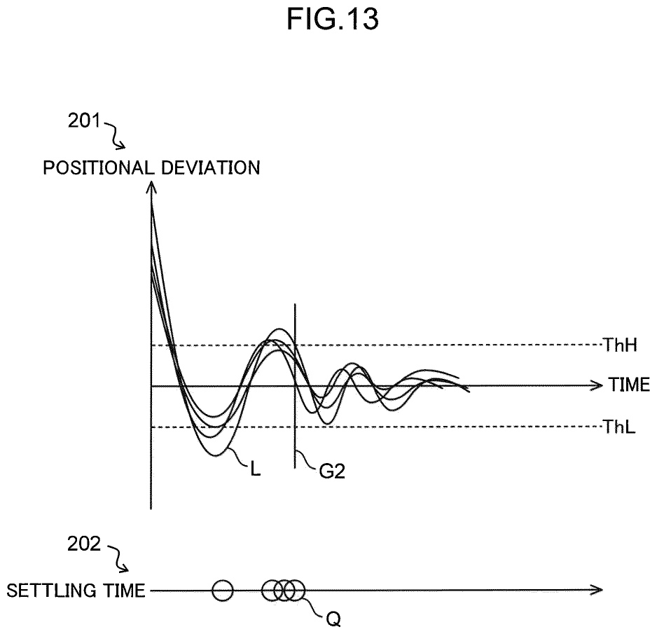

FIG. 13 is a diagram illustrating superimposed images 201 and 202 according to a second modification in a simplified manner. In the superimposed image 101 illustrated in FIG. 12, when the user performs a mouse click operation in a state where the mouse cursor is moved onto the figure G2 by an operation input using the input unit 13, selection information of the figure G2 is received by the reception unit 27. The creation unit 26 creates the superimposed images 201 and 202 corresponding to the evaluation operation in which the worst evaluation value among the plurality of waveforms L is the best among the plurality of evaluation operations executed up to the present time. The superimposed image 201 includes a plurality of waveforms L and a figure G2. The superimposed image 202 includes a plurality of evaluation values (in this example, a plurality of settling times Q) corresponding to the plurality of waveforms L. Although FIG. 13 illustrates the waveform L and the settling time Q related to the four evaluation operations, in a case where the evaluation operation is all the operations, the superimposed images 201 and 202 may include the waveform L and the settling time Q related to all the operations.

According to the present modification, since the user can easily compare the evaluation value related to the current representative operation with the best evaluation value up to the present time, the convenience of the user can be improved.

### Third Modification

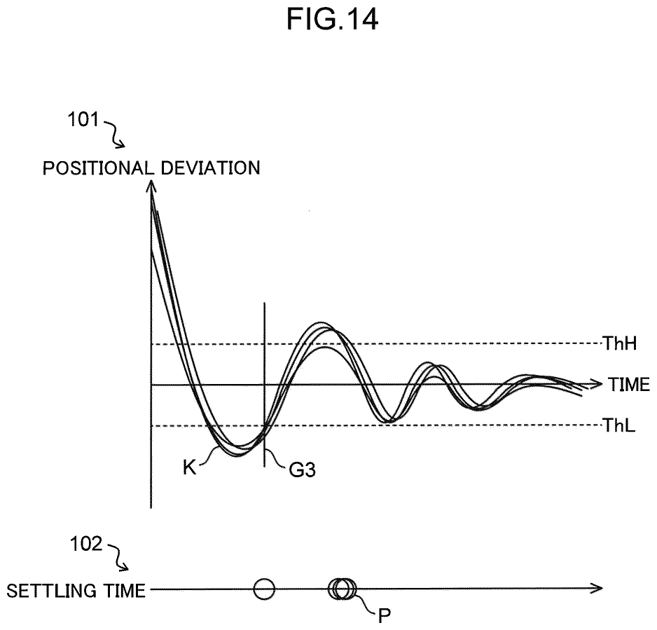

FIG. 14 is a diagram illustrating superimposed images 101 and 102 according to a third modification in a simplified manner. In the superimposed image 101 illustrated in FIGS. 9, 11, and 12, when the user performs a mouse click operation in a state where the mouse cursor is moved onto any of the waveforms K by an operation input using the input unit 13, selection information of the waveform K is received by the reception unit 27. The creation unit 26 reads the past measurement data 33 related to the operation corresponding to the selected waveform K from the storage unit 12, and creates the superimposed images 101 and 102 in which a plurality of pieces of waveform information regarding the operation are superimposed. The superimposed image 101 includes a plurality of waveforms K related to the operation and a figure G3 indicated by a vertical line. The figure G3 is a figure for clearly indicating an evaluation value corresponding to a waveform having the best evaluation value (in this example, the minimum settling time P) among the plurality of waveforms K related to the operation. In addition, the output unit 25 displays the operation screen 100 on the display unit 14 by inputting the data of the operation screen 100 created by the creation unit 26 to the display unit 14.

According to the present modification, since the superimposed images 101 and 102 related to the specific operation corresponding to the waveform K selected by the user is displayed on the display unit 14, the convenience of the user can be improved.

### Fourth Modification

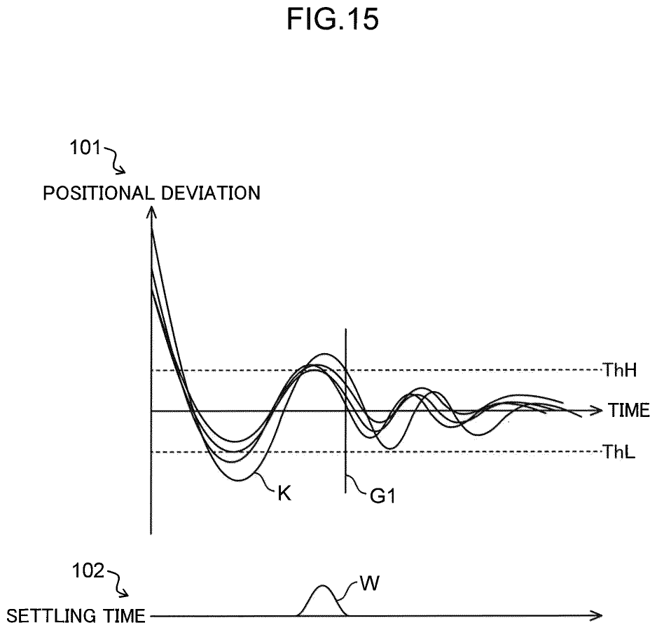

FIG. 15 is a diagram illustrating superimposed images 101 and 102 according to a fourth modification in a simplified manner. In the above-described superimposed images 102 and 202, the plurality of evaluation values are indicated on the time axis by the plots of the circles, but when the number of evaluation values increases, the plurality of circles overlap each other, and the visibility decreases. Therefore, the creation unit 26 creates the superimposed image 102 using a graph W representing the frequency distribution of the plurality of evaluation values by the height of the mountain. Note that the graph W may represent the frequency distribution by the type of coloring, gray scale shading, or the like instead of the height of the mountain.

According to the present modification, it is possible to improve the visibility of the superimposed images 102 and 202 including a plurality of evaluation values.

### Fifth Modification

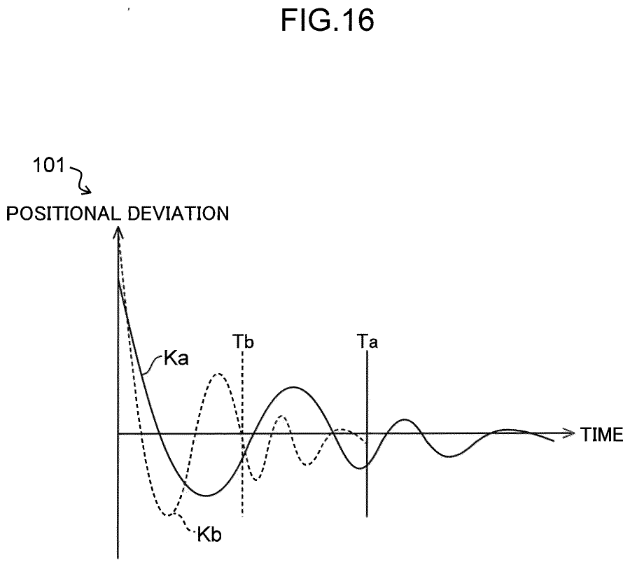

FIG. 16 is a diagram illustrating a superimposed image 101 in a simplified manner. In the above description, the update unit 24 has executed the optimization of shortening the longest settling time among the settling times corresponding to the respective operations included in the representative operations. Here, the target settling time of each operation varies depending on the moving distance and the like in each operation. For example, as illustrated in FIG. 16, a target settling time Tb for the waveform Kb of the operation having the short moving distance is shorter than a target settling time Ta for the waveform Ka of the operation having the long moving distance.

Therefore, the target settling time of each operation is stored in the storage unit 12, and the creation unit 26 shifts or scales the waveform K of each operation in the time axis direction so that the target settling time of each operation coincides on the time axis in the creation of the superimposed images 101 and 201.

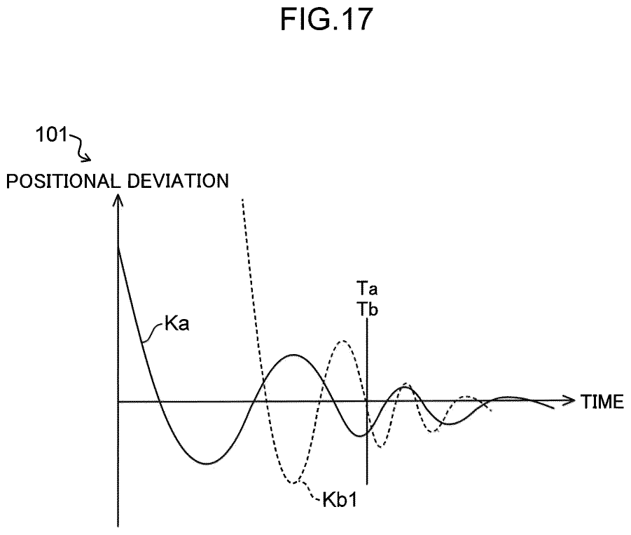

FIG. 17 is a diagram illustrating a first example of a superimposed image 101 according to a fifth modification in a simplified manner. The creation unit 26 superimposes a waveform Kb1 on the waveform Ka instead of the waveform Kb by shifting (moving rightward in this example) the waveform Kb on the time axis such that the target settling time Tb matches the target settling time Ta.

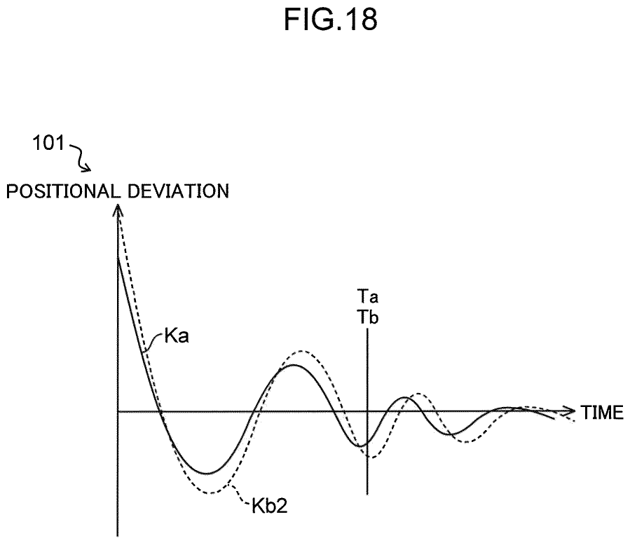

FIG. 18 is a diagram illustrating a second example of the superimposed image 101 according to the fifth modification in a simplified manner. The creation unit 26 superimposes a waveform Kb2 on the waveform Ka instead of the waveform Kb by scaling (expanding rightward in this example) the waveform Kb on the time axis such that the target settling time Tb matches the target settling time Ta.

According to the present modification, since the waveform information shifted or scaled according to the target value related to the evaluation index in each operation can be displayed, the waveform information having the worst evaluation value (that is, the waveform information to be updated by the update unit 24) can be appropriately specified, and the convenience of the user can be improved.

### INDUSTRIAL APPLICABILITY

The present disclosure is widely applicable to a system or the like that generates control parameters.

1. An information processing method for optimizing control parameters in a device that executes an operation based on a plurality of the control parameters, the method performed by an information processing unit, comprising:
causing the device to execute a plurality of operations included in all operations that can be executed by the device;
acquiring a plurality of pieces of time-series measurement data related to a predetermined evaluation index measured in execution of each operation of the plurality of operations;
creating a waveform based on the plurality of pieces of measurement data related to the respective operations, creating a superimposed image by superimposing a plurality of pieces of waveform information regarding the plurality of operations, and creating an operation screen including the superimposed image; and
causing a display unit to display the operation screen by inputting data of the operation screen to the display unit.

2. The information processing method according to claim 1, wherein the plurality of operations are all the operations or a plurality of representative operations selected from all the operations.

3. The information processing method according to claim 2, further comprising:
receiving an operation input of selection information for selecting one piece of waveform information from the plurality of pieces of waveform information included in the operation screen displayed on the display unit; and
changing the representative operation based on the selection information.

4. The information processing method according to claim 1, wherein the plurality of pieces of waveform information are a plurality of waveforms related to the plurality of operations or a plurality of evaluation values calculated based on the plurality of waveforms.

5. The information processing method according to claim 1, wherein in the creating of the superimposed image, a display mode of the waveform information that has achieved a target value related to the evaluation index and a display mode of the waveform information that has not achieved the target value are made different from each other among the plurality of pieces of waveform information.

6. The information processing method according to claim 1, wherein
the operation screen further includes a first input field for selecting display of the waveform information that has achieved a target value related to the evaluation index among the plurality of pieces of waveform information, and a second input field for selecting display of the waveform information that has not achieved the target value, and
in the creating of the superimposed image,
in a case where selection information is input to the first input field, the waveform information that has achieved the target value among the plurality of pieces of waveform information is included in the superimposed image, and
in a case where selection information is input to the second input field, the waveform information that has not achieved the target value among the plurality of pieces of waveform information is included in the superimposed image.

7. The information processing method according to claim 1, wherein
the operation screen further includes a first input field for selecting a first evaluation index and a second input field for selecting a second evaluation index as the evaluation index, and
in the creating of the waveform,
in a case where selection information is input to the first input field, the waveform is created based on the plurality of pieces of time-series measurement data related to the first evaluation index measured in execution of the operations, and
in a case where selection information is input to the second input field, the waveform is created based on the plurality of pieces of time-series measurement data related to the second evaluation index measured in execution of the operations.

8. The information processing method according to claim 1, wherein
in the creating of the waveform, a plurality of waveforms are created for the operations by causing the device to execute the operations a plurality of times, and
in the creating of the superimposed image,
waveform information having a best evaluation value related to the evaluation index is selected among a plurality of pieces of waveform information regarding each of the operations, and
the superimposed image is created by superimposing a plurality of pieces of best waveform information regarding the plurality of operations.

9. The information processing method according to claim 1, wherein
in the creating of the superimposed image,
the waveform information regarding the operations is shifted or scaled in a time axis direction according to a target value related to the evaluation index in the operations.

10. An information processing method for optimizing control parameters in a device that executes an operation based on a plurality of the control parameters, the method performed by an information processing unit, comprising:
causing the device to execute a plurality of operations;
acquiring a plurality of pieces of time-series measurement data related to a predetermined evaluation index measured in execution of each operation of the plurality of operations;
creating a waveform based on the plurality of pieces of measurement data related to the respective operations, creating a superimposed image by superimposing a plurality of pieces of waveform information regarding the plurality of operations, and creating a screen including the superimposed image; and
causing a display unit to display the screen by inputting data of the screen to the display unit, wherein
the superimposed image includes a figure that clearly indicates an evaluation value corresponding to waveform information having a worst evaluation value related to the evaluation index among the plurality of pieces of waveform information.

11. An information processing device for optimizing control parameters in a device that executes an operation based on a plurality of the control parameters, the information processing device comprising a processor, wherein the processor:
causes the device to execute a plurality of operations included in all operations that can be executed by the device;
acquires a plurality of pieces of time-series measurement data related to a predetermined evaluation index measured in execution of each operation of the plurality of operations;
creates a waveform based on the plurality of pieces of measurement data related to the respective operations, creates a superimposed image by superimposing a plurality of pieces of waveform information regarding the plurality of operations, and creates an operation screen including the superimposed image; and
causes a display unit to display the operation screen by inputting data of the operation screen to the display unit.

12. A computer-readable non-transitory recording medium recording a program for causing an information processing device for optimizing control parameters in a device that executes an operation based on a plurality of the control parameters to execute processing,
the processing including:
causing the device to execute a plurality of operations included in all operations that can be executed by the device;
acquiring a plurality of pieces of time-series measurement data related to a predetermined evaluation index measured in execution of each operation of the plurality of operations;
creating a waveform based on the plurality of pieces of measurement data related to the respective operations, creating a superimposed image by superimposing a plurality of pieces of waveform information regarding the plurality of operations, and creating an operation screen including the superimposed image; and
causing a display unit to display the operation screen by inputting data of the operation screen to the display unit.
